(19) United States
(12) Patent Application Publication
(10) Pub. No.: US 2020/0091794 A1
(43) Pub. Date: Mar. 19, 2020

(54) Electric Pump

(71) Applicant: AISAN KOGYO KABUSHIKI KAISHA, Obu-shi (JP)

(72) Inventors: Yoshihiko HONDA, Obu-shi (JP); Shota TSUKAMOTO, Kariya-shi (JP); Naoki SHIRAI, Toyohashi-shi (JP)

(73) Assignee: AISAN KOGYO KABUSHIKI KAISHA, Obu-shi (JP)

(21) Appl. No.: 16/560,947

(22) Filed: Sep. 4, 2019

(30) Foreign Application Priority Data
Sep. 13, 2018 (JP) 2018-171456

(51) Int. Cl. H02K 3/52; H02K 5/06; H02K 7/14; H02K 9/22; H02K 11/22; H02K 11/33; H02K 21/16; F04D 25/06; F04D 29/046

(52) U.S. Cl. CPC H02K 3/522; H02K 5/06; H02K 7/14; H02K 9/22; H02K 2211/03; H02K 11/33; H02K 21/16; F04D 25/0693; F04D 29/046; H02K 11/022

(57) ABSTRACT

An electric pump includes an impeller and a brushless motor including a rotor, a stator, a circuit board, and a coil terminal. The rotor is coupled to the impeller. The stator includes a plurality of stator coils circumferentially disposed around or within the rotor and include a first stator coil. The circuit board extends in a plane crossing with an axial direction of the rotor and includes an electric circuit. The coil terminal electrically couples the first stator coil and the electric circuit of the circuit board. The coil terminal extends from the circuit board and is disposed outside or inside the first stator coil in the radial direction. The coil terminal includes a coil-side end positioned further away from the circuit board in the axial direction than at least a portion of the first stator coil. The coil terminal is coupled to the first stator coil via the coil-side end.

### CROSS-REFERENCE TO RELATED APPLICATIONS

This application claims priority to Japanese patent application serial number 2018-171456, filed Sep. 13, 2018, which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates generally to electric pumps, more specifically electric pumps each including a brushless motor.

Some electric pumps are equipped with a brushless motor. The brushless motor includes stator coils and a circuit board. The circuit board includes terminals extending toward the stator coils in the axial direction of the brushless motor. The circuit board is connected to the stator coils via the terminals supplying power to the stator coils.

### BRIEF SUMMARY

In one aspect of this disclosure, an electric pump includes an impeller and a brushless motor including a rotor, a stator, a circuit board, and a coil terminal. The rotor is coupled to the impeller. The stator includes a plurality of stator coils arranged circumferentially around or within the rotor. The circuit board extends in a plane crossing an axial direction of the rotor and includes an electric circuit. The coil terminal electrically connects a first stator coil of the plurality of stator coils and the electric circuit of the circuit board. The coil terminal extends from the circuit board and is disposed outside or inside the first stator coil in the radial direction. The coil terminal includes a coil-side end positioned further away from the circuit board in the axial direction than at least a portion of the first stator coil. The coil terminal is connected to the first stator coil via the coil-side end.

According to this aspect, the coil terminal is disposed outside or inside the first stator coil in the radial direction and is coupled to the first stator coils via the coil-side end. Thus, a space for the coil terminal is not required between the stator coils and the circuit board in the axial direction. This allows the circuit board to be axially disposed adjacent to the coil terminals. Accordingly, the size of the electric pump in the axial direction can be decreased.

Other objects, features and advantage of the present teaching will be readily understood after reading the following detailed description together with the accompanying drawings and the claims.

### BRIEF DESCRIPTION OF THE DRAWINGS

For a detailed description of the preferred embodiments of the present teaching, reference will now be made to the accompanying drawings.

FIG. 1 is a perspective view of an embodiment of an electric pump in accordance with principles described herein.

FIG. 2 is a side view of the electric pump of FIG. 1.

FIG. 3 is a top view of the electric pump of FIG. 1.

FIG. 4 is a cross-sectional view of the electric pump of FIG. 1 taken along section IV-IV line of FIG. 2.

FIG. 5 is a cross-sectional view of the electric pump of FIG. 1 taken along section V-V line of FIG. 2.

FIG. 6 is a cross-sectional view of the electric pump of FIG. 1 taken along section VI-VI line of FIG. 4.

FIG. 7 is a cross-sectional view of the electric pump of FIG. 1 taken along section VII-VII line of FIG. 5.

FIG. 8 is a cross-sectional view of the electric pump of FIG. 1 taken along section VIII-VIII line of FIG. 5.

FIG. 9 is a cross-sectional view of the electric pump of FIG. 1 taken along section IX-IX line of FIG. 5.

FIG. 10 is a perspective view of a part of the electric pump of FIG. 1.

FIG. 11 is a perspective view of the part of the electric pump of FIG. 1, which is viewed from a different direction from the view of FIG. 10.

FIG. 12 is an exploded view of the electric pump of FIG. 1.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different people may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections.

Each of the additional features and teachings disclosed above and below may be utilized separately or in conjunction with other features and teachings to provide improved electric pumps. Representative examples of the present teachings, which examples utilized many of these additional features and teachings both separately and in conjunction with one another, will now be described in detail with reference to the attached drawings. This detailed description is merely intended to teach a person skilled in the art further details for practicing preferred aspects of the present teachings and is not intended to limit the scope of the claimed subject-matter. Only the claims define the scope of the claimed subject-matter. Therefore, combinations of features and steps disclosed in the following detailed description may not be necessary to practice the claimed subject-matter in the broadest sense, and are instead taught merely to particularly describe representative examples of the present teachings. Moreover, various features of the representative examples and the dependent claims may be combined in ways that are not specifically enumerated in order to provide additional useful embodiments of the present teachings.

To reduce the space taken by electric pumps, downsizing may be desired. However, in the case of a conventional electric pump, the terminals are positioned between the circuit board and the stator coils in the axial direction, and thus, it is difficult to decrease the axial size of the electric pump. Therefore, there has been a need for improved electric pumps.

One embodiment of the present teaching will be described with reference to accompanying drawings. An electric pump of the present embodiment is a purge pump 1 (hereinafter, also referred to as “pump”) that is incorporated in an evaporative emission system of a vehicle equipped with an internal combustion engine, such as an automobile. In each drawing, an arrow F defines a frontward direction of the purge pump 1, and an arrow B defines a backward direction thereof.

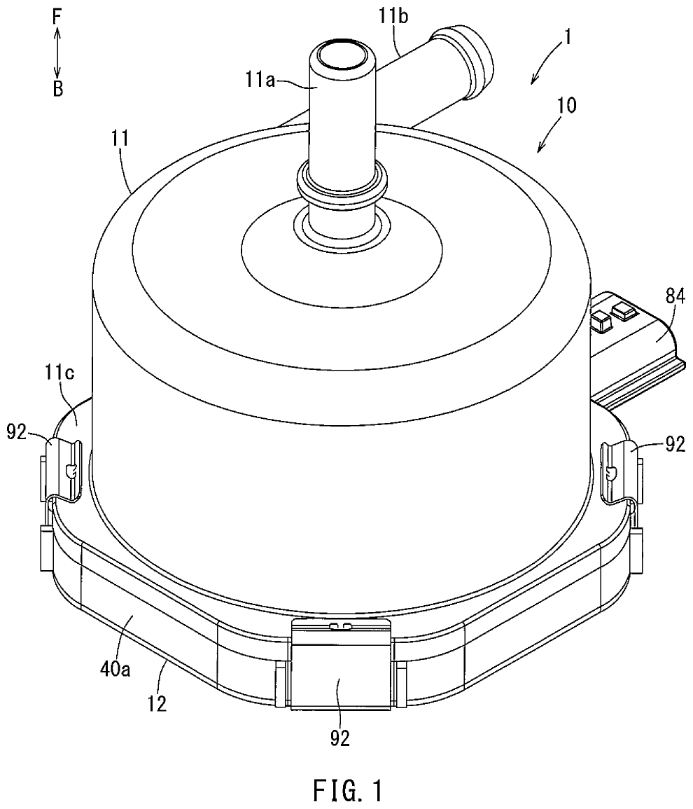

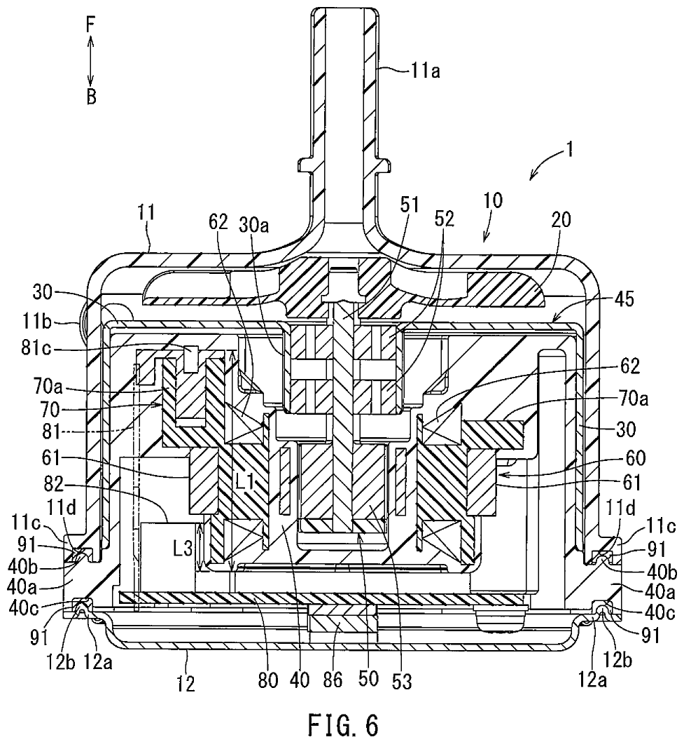

Referring now to FIGS. 6 to 9, in this embodiment, the purge pump 1 includes a cover 10, an impeller 20, and a brushless motor 45. The cover 10 may be made from a resin material and includes a front cover 11 disposed at the front and a rear cover 12 disposed at the rear. The front cover 11 has a substantial hollow cylindrical shape, with a front plate narrowing an opening at a front end of the front cover 11. The front cover 11 includes a flange part 11c extending radially outward from the rear end thereof. The rear cover 12 has a substantial thin plate shape closing a rear end of the front cover 11, such that the cover 10 can house other components of the pump 1 therein. The rear cover 12 has a flange part 12a extending radially outward from the outer periphery thereof. The brushless motor 45 includes a rotor 50 and a stator 60 concentrically disposed around the rotor 50 such that the rotor 50 can rotate relative to the stator 60. The rotor 50 includes a rotation shaft 51 extending in the front-rear direction. The impeller 20 is fixably attached to a front end of the rotation shaft 51 so as to be rotatable therewith. As shown in FIGS. 1 to 3, the front cover 11 includes an inlet port 11a and an outlet port 11b. The inlet port 11a extends frontward from the front plate of the front cover 11. As shown in FIGS. 6 to 9, the inlet port 11a is concentrically arranged relative to the impeller 20 and the rotor 50. As shown in FIGS. 1 to 3, the outlet port 11b extends outward from an outer circumference of the front cover 11 along a plane perpendicular to the axis of the inlet port 11a. More specifically, the outlet port 11b extends tangentially (e.g., in the tangential direction) from the outer periphery of the impeller 20. Thus, when the impeller 20 is rotated, the purge pump 1 suctions fuel vapor from the evaporative emission system (not shown) via the inlet port 11a and then discharges it from the outlet port 11b. The discharged fuel vapor may be supplied to the internal combustion engine (not shown).

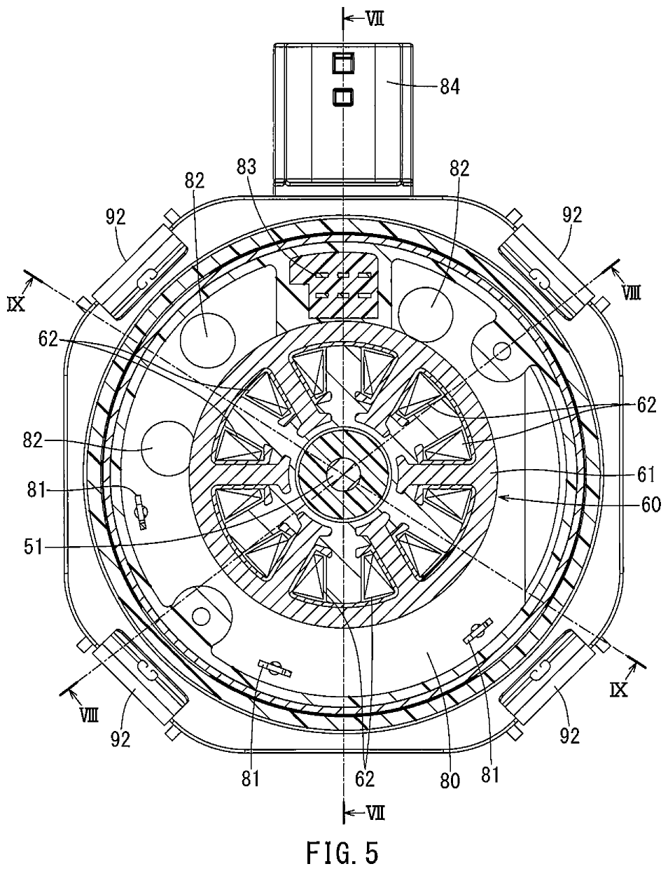

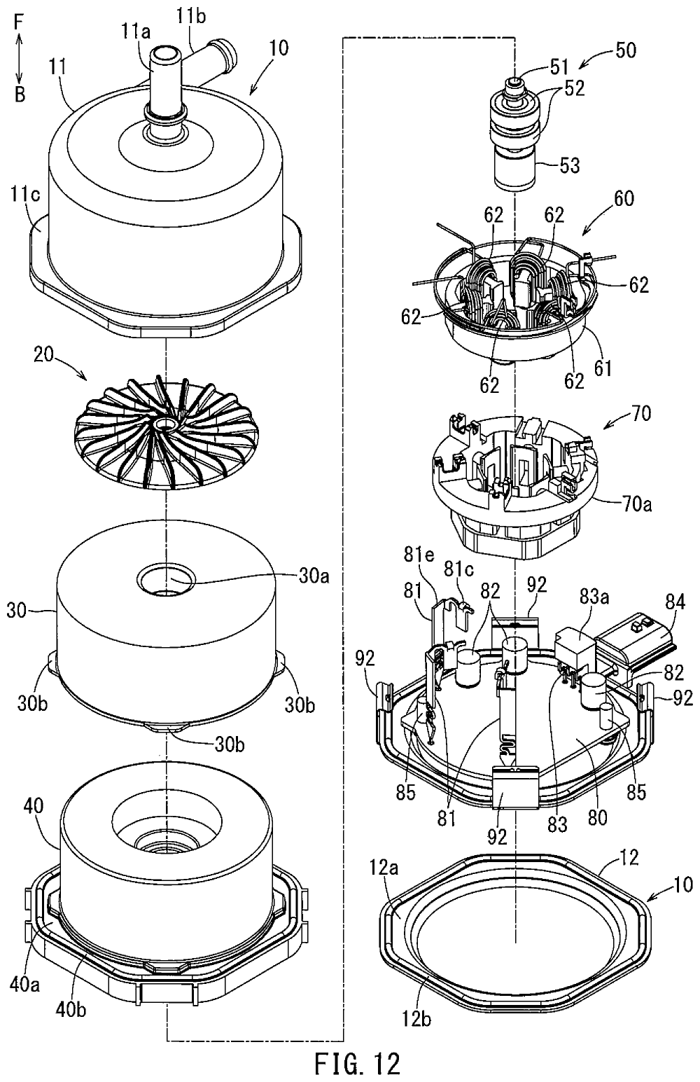

As shown in FIGS. 5 and 12, the stator 60 includes a stator core 61 and a plurality of stator coils 62. In this embodiment, the stator 60 includes six stator coils 62. The stator coils 62 are circumferentially arranged such that the stator 60 has six magnetic poles. More specifically, three of the stator coils 62 may be assigned with the U-phase stator coil, the V-phase stator coil, or the W-phase stator coil, respectively, based on the kind of the three-phase electric power applied from an electric circuit (an embodiment of which is described below). These stator coils 62 are coupled with each other in wye (Y) configuration (also referred to as “star configuration”). The other three stator coils 62 may be connected in series to the U-phase, V-phase, and W-phase stator coils 62, respectively. The stator coils 62 are arranged in the circumferential direction such that the stator coils 62 assigned with the same phase may be opposite to each other across the axis of the stator 60. That is, the stator 62 may be a three-phase six-pole stator. The stator coils 62 may be connected with each other in a delta (A) or other configuration.

As shown in FIGS. 6 to 9, the pump 1 includes a stator body 70. As shown in FIG. 12, the stator body 70 has a substantially hollow cylindrical shape and includes a flange part 70a protruding radially outward from a front end of the stator body 70. The stator body 70 may be made from a resin material. As shown in FIGS. 6 to 11, the stator body 70 firmly holds the stator core 61 and the stator coils 62 so as to maintain positional relationship of the stator core 61 and the stator coils 62. The stator body 70 houses conductive wires therein for coupling the stator coils 62 in the desired configuration, for example the Y configuration.

As shown in FIGS. 6 to 9, the brushless motor 45 includes a molded body 40 that may be formed by resin molding. The molded body 40 supports the rotor 50 and the stator 60 such that the rotor 50 is rotatably positioned at the center of the circumferentially arranged stator coils 62. More specifically, the brushless motor 45 includes a pair of bearings 52 that support and allow rotation of the rotation shaft 51 of the rotor 50. The molded body 40 supports the bearings 52 with the rotor 50 disposed at the center of the molded body 40. The bearings 52 are arranged outside of the stator coils 62 in the axial direction of the rotation shaft 51, more specifically, in front of the stator coils 62 in the axial direction. Further, the rotor 50 includes magnets 53 attached to and positioned around a rear end of the rotation shaft 51. The magnets 53 are positioned inside of the stator coils 62 in the radial direction. That is, the bearings 52 are positioned between the impeller 20 and the magnets 53 in the axial direction.

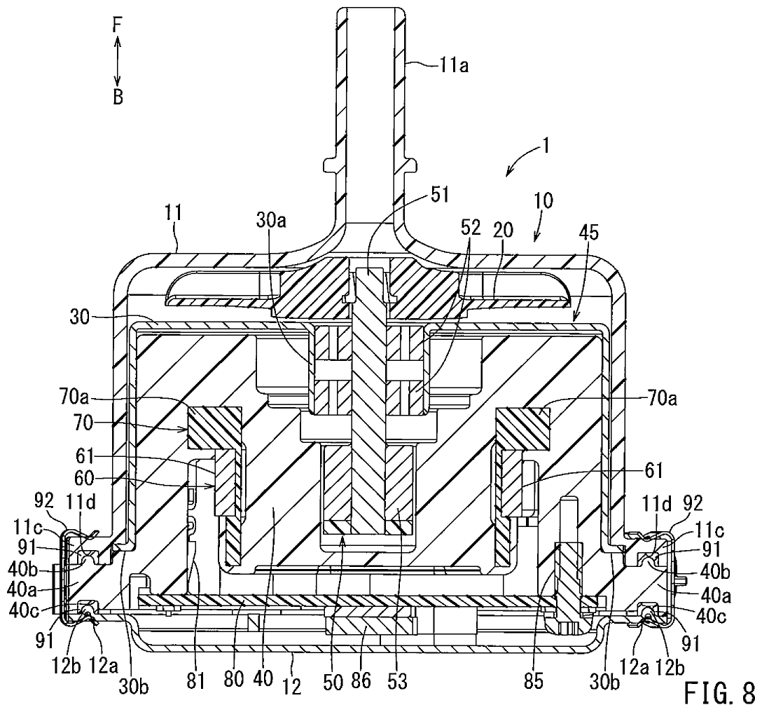

As shown in FIGS. 6 to 9 and 12, the molded body 40 has a substantially hollow cylindrical structure and includes a flange part 40a protruding radially outward from a rear end of the molded body 40. As shown in FIG. 8, the flange part 40a of the molded body 40 is positioned between and firmly coupled to the flange part 11c of the front cover 11 and the flange part 12a of the rear cover 12, for example by attaching clamps 92 to the flange part 11c and the flange part 12a.

As shown in FIGS. 6 to 9, the flange part 11c of the front cover 11 has a groove 11d that is recessed from the rear surface of the flange part 11c. The groove 11d may extend over almost the whole circumference of the flange part 11c. The flange part 40a of the molded body 40 has a projecting strip 40b protruding forward from a front surface of the flange part 40a. The projecting strip 40b may extend over almost the whole circumference of the flange part 40a. The projecting strip 40b has a shape that can be loosely fit within the groove 11d. Because the projecting strip 40b is loosely fit in the groove 11d, there is a space between the projecting strip 40b and the groove 11d. Similarly, the flange part 12a of the rear cover 12 has a projecting strip 12b protruding forward from a front surface of the flange part 12a. The projecting strip 12b may extend over almost the whole circumference of the flange part 12a. The flange part 40a of the molded body 40 has a groove 40c recessed from a rear surface of the flange part 40a. The groove 40c may extend over almost the whole circumference of the flange part 40a. The projecting strip 12b has a shape that can be loosely fit within the groove 40c such that there is a space between the projecting strip 12b and the groove 40c. The space between the projecting strip 40b and the groove 11d and the space between the projecting strip 12b and the groove 40c are filled with seal members 91 by injecting a curable liquid seal agent into the spaces and solidifying the seal agent so as to seal the spaces.

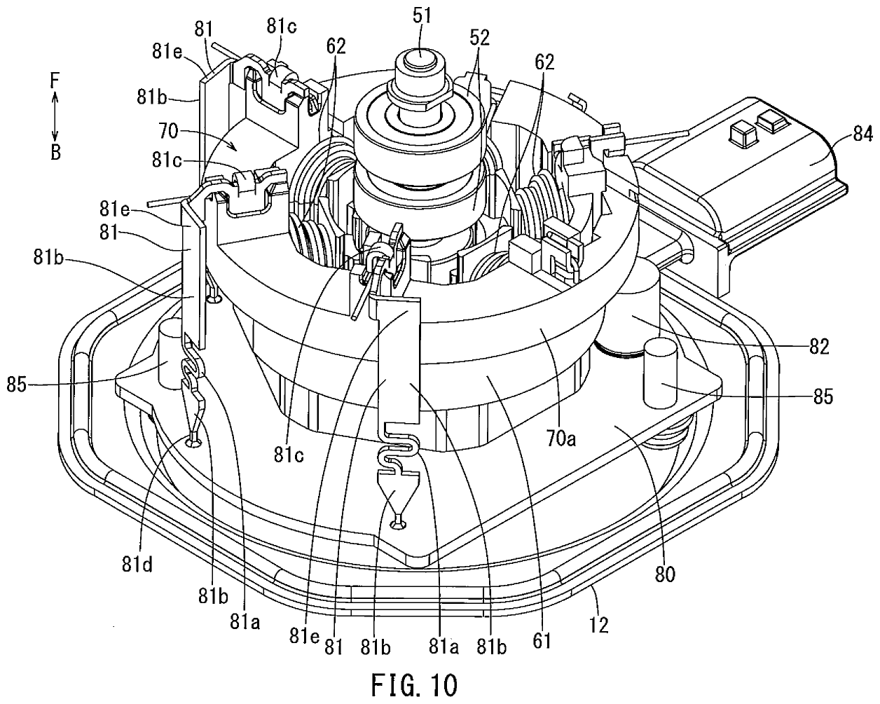

As shown in FIG. 8, the brushless motor 45 includes a circuit board 80 positioned between the molded body 40 and the rear cover 12. The circuit board 80 has a thin plate or board shape oriented perpendicular to the axial direction of the rotor 50. In this embodiment, the circuit board 80 is fixably coupled to the rear surface of the molded body 40 with a pair of pins 85 (one of them is shown in FIG. 8). The circuit board 80 is connected on a rear surface side thereof with circuit elements 86, such as an integrated circuit (IC) chip or the like. The circuit elements 86 form an electric circuit. As shown in FIGS. 10 to 12, three coil terminals 81, three capacitors 82, and a power terminal 83 are installed upright on an outer peripheral part of a front surface of the circuit board 80 and are electrically coupled to the electric circuit of the circuit board 80.

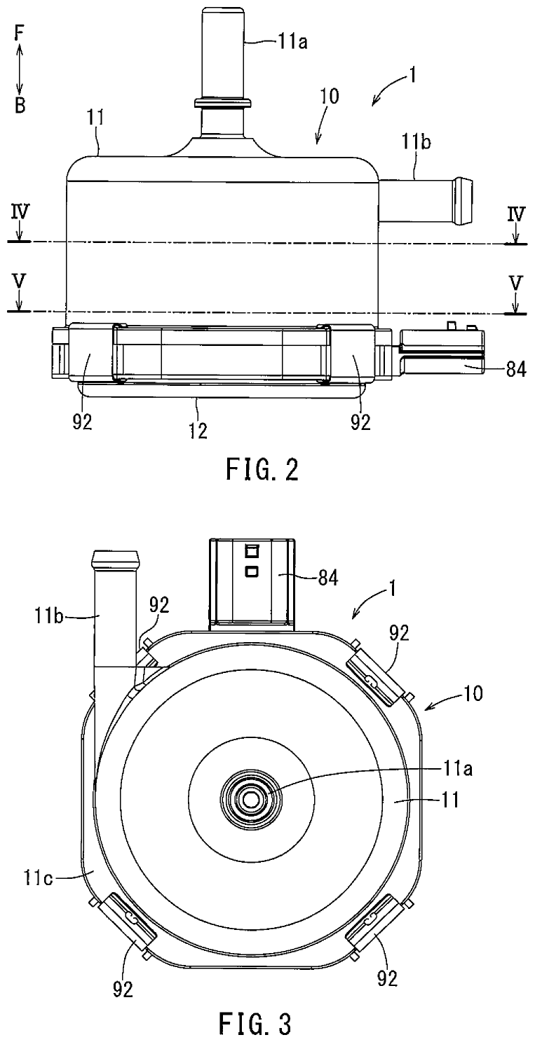

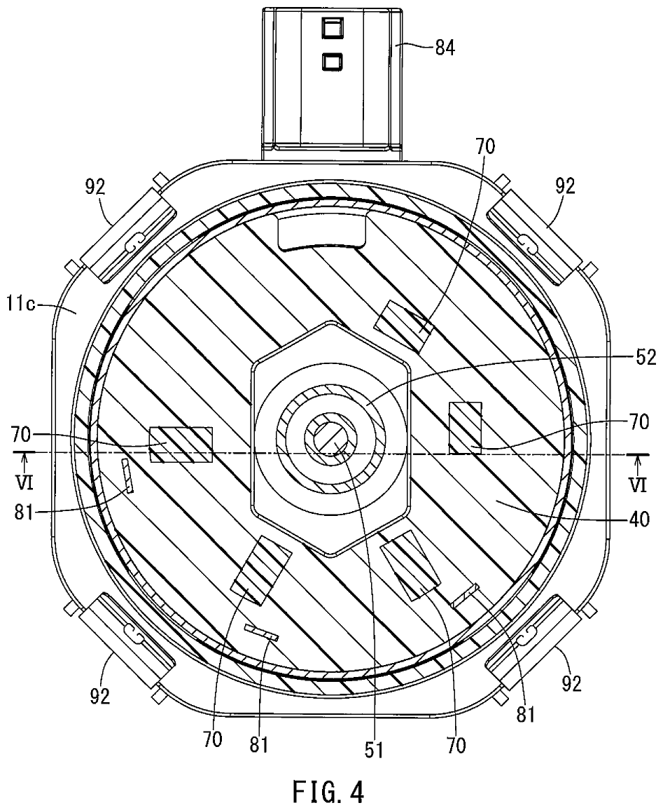

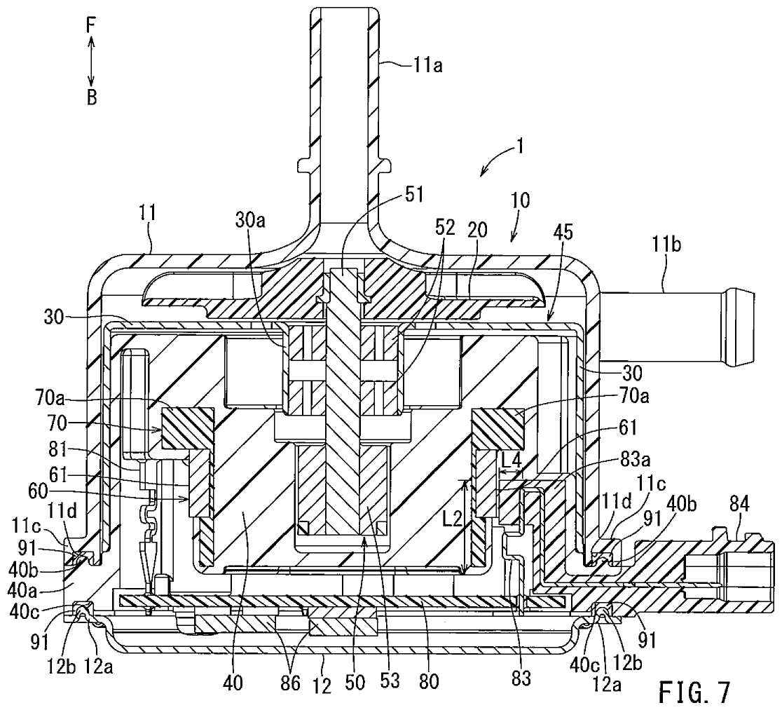

Each of the three coil terminals 81 may be assigned with the U-phase, V-phase, or W-phase, and may be arranged radially outside of the corresponding stator coils 62 based on the phase. The power terminal 83 is configured to transmit electricity from an external power source (not shown) to the electric circuit of the circuit board 80. As shown in FIGS. 2 to 4, the pump 1 includes a connector 84 extending radially in a direction perpendicular to the axis of the rotation shaft 51. As shown in FIG. 7, the power terminal 83 is bent into the connector 84 and is coupled to the external power source. Two of the capacitors 82 are configured to absorb a surge current generated when varying current to the stator coils 62. The other capacitor 82 is used as a power source for the electric elements 86, such as IC ships. As shown in FIGS. 10 to 12, the capacitors 82 and the power terminal 83 are positioned radially outside of the stator coils 62 together with the coil terminals 81.

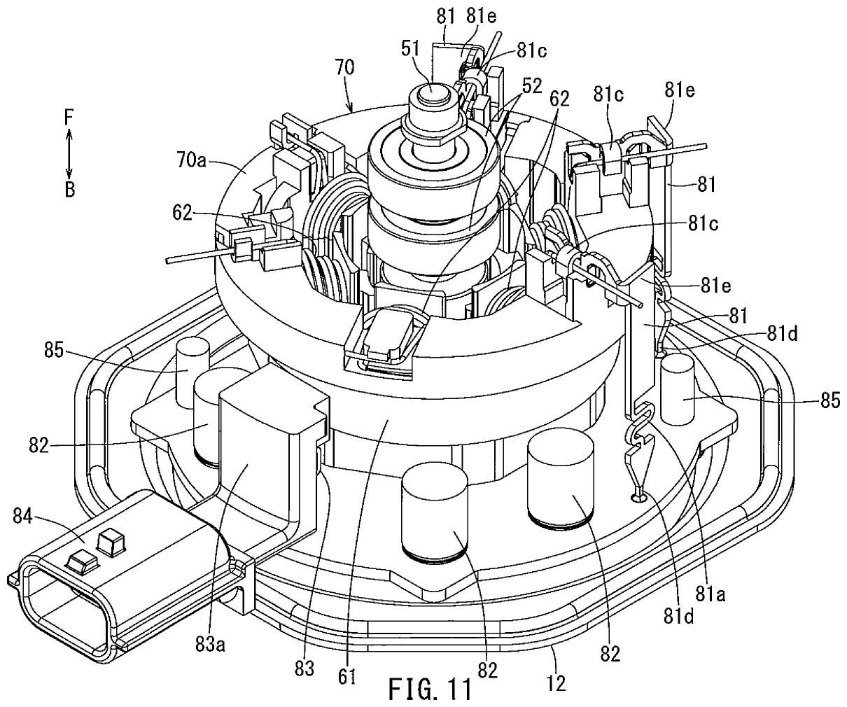

Next, an embodiment of the structure of the coil terminals 81 will be described in detail. The coil terminals 81 have substantially the same shape as each other. Accordingly, only one of the coil terminals 81 will be described as an example. As shown in FIGS. 10 and 11, the coil terminal 81 has an elongated shape extending forward from the circuit board 80 and includes a board-side end 81d at a rear end thereof and a coil-side end 81e at a front end thereof. The board-side end 81d is coupled to the electric circuit of the circuit board 80 by soldering. The coil-side end 81e is coupled to one of the stator coils 62. For example, the coil terminal 81 includes a connection part 81c extending radially inward from the coil-side end 81e and toward the corresponding stator coil 62. A part of the connection part 81c is bent to hold a connection part of the stator coil 62 therebetween and then soldered to the stator coil 62. Thus, the coil terminal 81 is electrically coupled with the stator coil 62 via the coil side end 81e.

In this embodiment, the coil terminal 81 is positioned radially outside of the stator coils 62 and electrically couples the circuit board 80 to one of the stator coils 62. Further, the coil terminal 81 is coupled to one of the stator coils 62 via the connection part 81c that is positioned away from the circuit board 80. That is, the coil terminal 81 is not disposed in a space between the stator coils 62 and the circuit board 80 in the axial direction. Thus, the circuit board 80 is positioned adjacent to the stator coils 62 in the axial direction, so that the axial size of the brushless motor 45 can be decreased.

As shown in FIG. 6, the coil terminal 81 and the connection part 81c are positioned radially outside of the stator coils 62 and the bearings 52. The coil terminal 81 radially overlaps the front-side bearing 52 and the stator coil 62 that is connected to the coil terminal 81. The connection part 81c overlaps the front-side bearing 52 in the radial direction. The portion of these components that is overlapped is positioned between the front end of the front-side bearing 52 and the rear end of the stator coils 62 (the overlapping length L1 is shown in FIG. 6). The coil terminal 81 does not extend forward of the front-side bearing 52 in the axial direction. Additionally, most of the coil terminal 81 and the connection part 81c are disposed within a space radially outside of and overlapping with the stator coils 62 and the bearings 52. Thus, an increase in the axial size of the brushless motor 45 caused by the coil terminal 81 and the connection part 81c can be suppressed or reduced.

As shown in FIGS. 10 and 11, the coil terminal 81 includes a displacement absorbing part 81a between the coil-side end 81e and the board-side end 81d. The displacement absorbing part 81a has a zigzag shape that is elastically deformable for allowing relative displacement between the coil-side end 81e and the board-side end 81d in the axial direction of the rotation shaft 51 or in the direction perpendicular to the axial direction.

Thus, when the coil terminal 81 is expanded by heat or is vibrated by an external force, the displacement absorbing part 81a elastically deforms so as to absorb and accommodate the relative displacement between the coil-side end 81e and the board-side end 81d, thereby preventing disconnection between the circuit board 80 and the coil terminal 81. For example, the displacement adsorbing part 81a absorbs and accommodates such relative displacement so that it is able to reduce stress on the solder that connects the coil terminal 81 with the circuit board 80. Thus, the solder can be prevented from cracking, and thus decoupling of the coil terminal 81 and the circuit board 80 can be avoided.

The displacement absorbing part 81a may have any shape capable of absorbing the relative displacement other than the zigzag shape. However, because the zigzag shape of the displacement absorbing part 81a can be easily formed with minimal additional cost, the zigzag shape may be preferable. More specifically, the displacement absorbing part 81a having the zigzag shape can be formed at the same time that the coil terminal 81 is formed by press molding, stamping, or other method.

The coil terminal 81 is also be formed to be elastically deformable, for example due to the elongated shape thereof. Thus, even if the coil terminal 81 does not include the displacement absorbing part 81a, the coil terminal 81 is configured to absorb and accommodate the relative displacement between the coil-side end 81e and the board-side end 81d, to a certain degree. More specifically, when the coil terminal 81 expands with heat or is vibrated by an external force, the coil terminal 81 can bow such that the relative position between the board-side end 81d and the coil-side end 81e is maintained. Thus, the relative displacement between the board-side end 81d and the coil-side end 81e can be absorbed and accommodated such that the coupled state between the coil terminal 81 and the circuit board 80 is maintained.

As shown in FIGS. 10 and 11, the coil terminal 81 includes a pair of heat radiation parts 81b. Each of the heat radiation parts 81b has a plate shape with a relatively broad surface area so as to improve its heat radiation efficiency. One of the heat radiation parts 81b is positioned between the board-side end 81d and the displacement absorbing part 81a, and the other one is positioned between the displacement absorbing part 81a and the coil-side end 81e. The coil terminal 81 is coupled to the stator coil 62 via the connection part 81c, so that heat generated at the stator coil 62 is transferred to the coil terminal 81 via the connection part 81c. The heat may then be efficiently radiated from the heat radiation parts 81b. Thus, heat transferred from the stator coil 62 to the circuit board 80 via the coil terminal 81 is reduced or suppressed. Additionally, the increased length and total surface area of the coil terminal 81 further aids with radiating the heat. Accordingly, heat damage to the circuit board 80 can be decreased.

As shown in FIG. 7, the power terminal 83 is covered with a molded member 83a. The molded member 83a may be formed by resin molding and may be integrated with the connector 84 extending radially outward. The molded member 83a is supported by and within the molded body 40. The molded member 83a partially overlaps with one of the stator coils 62 in the radial direction of the rotation shaft 51 (the overlapping length L2 is shown in FIG. 7). Thus, an increase in the axial length of the brushless motor 45 can be reduced or suppressed.

As shown in FIG. 6, each capacitor 82 overlaps one of the stator coil 62 positioned adjacent to the capacitor 82 in the radial direction of the rotation shaft 51 (the overlapping length L3 is shown in FIG. 6). Thus, an increase in the axial length of the brushless motor 45 can be reduced or suppressed.

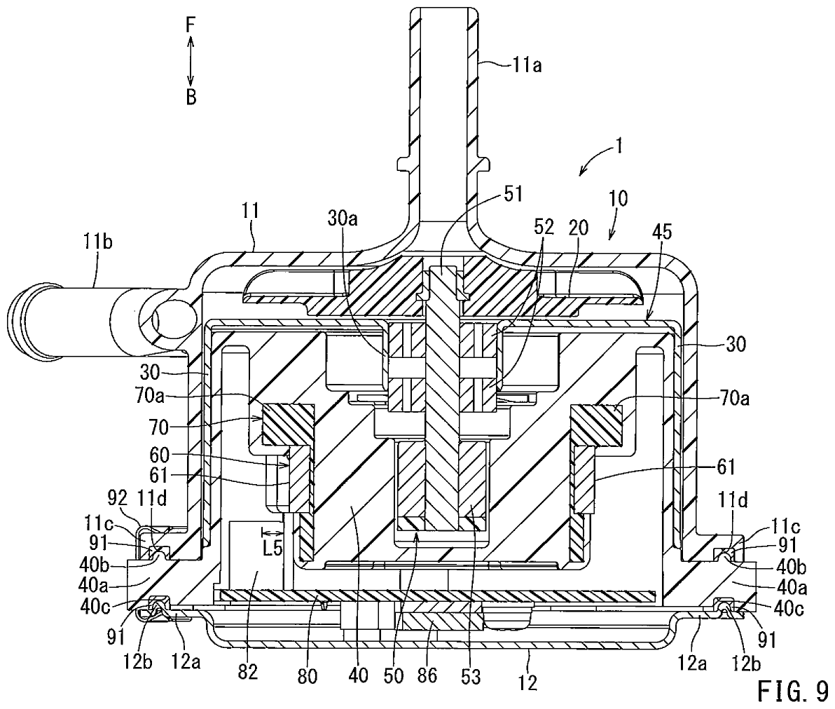

As shown in FIG. 7, a part of the molded member 83a is positioned between the flange part 70a of the stator body 70 and the circuit board 80 in the axial direction of the rotational shaft 51. They are arranged such that the molded member 83a partially overlaps with the flange part 70a in the direction parallel to the axial direction (the overlapping length L4 is shown in FIG. 7). Similarly, as shown in FIG. 9, each capacitor 82 is positioned between the flange part 70a and the circuit board 80 in the axial direction of the rotational shaft 51, such that the capacitor 82 partially overlaps the flange part 70a in the axial direction (the overlapping length L5 is shown in FIG. 9). Thus, an increase in the size of the brushless motor 45 in the radial direction can be reduced or suppressed.

As shown in FIGS. 6 to 9, the pump 1 includes a shield casing 30 that may be made from a metal material. The shield casing 30 has a hollow cylindrical shape and includes an annular front plate for narrowing an opening at a front end thereof. The shield casing 30 is held between an inner surface of the front cover 11 and an outer surface of the molded body 40, such that the impeller 20 is disposed between the front cover 11 and the shield casing 30. The shield casing 30 integrally includes a support part 30a that has a hollow cylindrical shape axially extending rearward from a central edge of the annular front plate of the shield casing 30. The bearings 52 are fitted into the support part 30a such that the support part 30a supports an outer circumference of each bearing 52. That is, the bearings 52 are supported by the molded body 40 via the shield casing 30. As shown in FIG. 8, the shield casing 30 integrally includes a flange part 30b extending radially outward from a rear end of the shield casing 30. The flange part 30b is firmly held between the flange part 11c of the front cover 11 and the flange part 40a of the molded body 40.

The shield casing 30 prevents leakage of noise caused by radio waves, which are generated by the electric circuit of the circuit board 80 and the stator coils 62, to outside of the pump 1. Further, the shield casing 30 functions as a heat radiator. More specifically, the support part 30a of the shield casing 30 receives heat from the bearings 52. The shield casing 30 conducts the heat to an outer circumference thereof and radiates the heat therefrom to the outside. In addition, when the conducted heat generated by the stator coils 62 is radiated from the heat radiation parts 81b of the coil terminals 81, the shield casing 30 receives the heat from the coil terminals 81 via the molded body 40 so as to radiate the heat to the outside of the pump 1.

According to the present embodiment, the stator coils 62 are coupled to the circuit board 80 via coil terminals 81 arranged radially outside of the stator coils 62. Thus, it is not necessary to provide a space for disposing the coil terminals 81 between the stator coils 62 and the circuit board 80 in the axial direction. Accordingly, the axial distance between the stator coils 62 and the circuit board 80 can be decreased, so that the size of the brushless motor 45 in the axial direction can be decreased. For example, in a case of an electric pump having a conventional brushless motor where coil terminals are disposed between stator coils and a circuit board in its axial direction, the axial length of the electric pump is about 60 mm. In contrast, the pump 1 of the present embodiment may have an axial length of about 42 mm, at least in part since the coil terminals 81 are not disposed between the stator coils 62 and the circuit board 80 in the axial direction. That is, the present teaching offers the potential to reduce the axial size of the electric pump by about 30%.

Further, the coil terminals 81, the capacitors 82, and the power terminal 83 are disposed on the front side of the circuit board 80, are positioned radially outside of the stator coils 62 and the bearings 52, and are overlapped by the stator body 70. Thus, the coil terminals 81, the capacitors 82, and the power terminal 83 do not increase the axial length of the brushless motor 45.

The coil terminals 81, the capacitors 82, and the power terminal 83 are disposed outside of the stator coils 62 in the radial direction of the stator 60, and are coupled to the outer peripheral part of the circuit board 80. That is, the outer peripheral part of the circuit board 80 is used for coupling the coil terminals 81, the capacitors 82, and the power terminal 83. Consequently, the electric circuit can be formed on a central part of the circuit board 80. Accordingly, an unused area of the circuit board 80 can be decreased.

The present teaching is not limited to the above-described embodiments and can be modified variously within the scope of the teaching. For example, the pump 1 may include a pressure sensor configured to detect pressure generated by the impeller 20. The heat radiation parts 81b may have other heat radiation means, such as coating of radiation paint or radiation grease. Each of the heat radiation parts 81b may have a zigzag shape. Each coil terminal 81 may have a single zigzag shape serving as both the displacement absorbing part 81a and the heat radiation part 81b. The rotor may be disposed radially outside of the stator such that the coil terminals are arranged radially inside of the stator coils of the stator.

What is claimed is:

1. An electric pump, comprising:
an impeller; and
a brushless motor comprising:
a rotor coupled to the impeller;
a stator including a plurality stator coils circumferentially arranged around or within the rotor and overlapping the rotor in a radial direction of the rotor, wherein the plurality of stator coils includes a first stator coil;
a circuit board extending in a plane crossing an axial direction of the rotor, wherein the circuit board includes an electric circuit; and
a coil terminal electrically connecting the first stator coil and the electric circuit of the circuit board,
wherein:
the coil terminal extends from the circuit board and is disposed outside or inside the first stator coil in the radial direction,
the coil terminal includes a coil-side end positioned further away from the circuit board in the axial direction than at least a portion of the first stator coil, and
the coil terminal is coupled to the first stator coil via the coil-side end.

2. The electric pump according to claim 1, wherein:
the coil terminal includes a board-side end coupled to the circuit board; and
the coil terminal is elastically deformable and configured to absorb relative displacement between the board-side end and the coil-side end.

3. The electric pump according to claim 2, wherein the coil terminal includes a zigzag-shaped part positioned between the board-side end and the coil-side end.

4. The electric pump according to claim 1, wherein the coil terminal includes a heat radiation part having a plate shape.

5. The electric pump according to claim 1, wherein:
the brushless motor includes a capacitor coupled to the stator coils; and
the capacitor is positioned on the circuit board and overlaps one of the stator coils in the radial direction.

6. The electric pump according to claim 5, wherein:
the stator includes a stator body supporting the stator coils;
the stator body includes a first end proximal the circuit board and a second end opposite to the first end in the axial direction;
the stator body includes a flange part protruding outward in the radial direction from the second end; and
the capacitor is positioned between the flange part and the circuit board in the axial direction and overlaps the flange part in the axial direction.

7. The electric pump according to claim 1, wherein:
the brushless motor includes a power terminal configured to supply electric power to electric circuit of the circuit board; and
the power terminal is positioned on the circuit board and overlaps one of the stator coils in the radial direction.

8. The electric pump according to claim 7, wherein:
the stator includes a stator body supporting the stator coils;
the stator body includes a first end proximal the circuit board and a second end opposite to the first end in the axial direction;
the stator body includes a flange part protruding outward in the radial direction from the second end; and
the power terminal is positioned between the flange part and the circuit board in the axial direction and overlaps the flange part in the axial direction.
